(19) United States
(12) Patent Application Publication
(10) Pub. No.: US 2024/0028484 A1
(43) Pub. Date: Jan. 25, 2024

(54) AUTOMATIC DISCOVERY OF APPLICATION RESOURCES FOR APPLICATION BACKUP IN A CONTAINER ORCHESTRATION PLATFORM

(71) Applicant: VMWARE, INC., Palo Alto, CA (US)

(72) Inventors: GIRISH SHANKAR SADHANI, Bangalore (IN); SHOBHA M, Bangalore (IN); RAMYA BANGERA, Bangalore (IN)

(21) Appl. No.: 17/976,898

(22) Filed: Oct. 31, 2022

(30) Foreign Application Priority Data
Jul. 22, 2022 (IN) 202241042203

(51) Int. Cl. G06F 11/14

(52) U.S. Cl. CPC G06F 11/1469; G06F 11/1464; G06F 11/1451

(57) ABSTRACT

Computer-implemented methods, media, and systems for automatic discovery of application resources for application backup in a container orchestration platform (e.g., a Kubernetes system) are disclosed. In an example method, a pod of an application deployed in a container orchestration platform is identified. Then an owner object of the pod is determined. Resources mounted on the pod and on the owner object of the pod in the container orchestration platform are checked. Based on the pod, the owner object of the pod, and the resources mounted on the pod and on the owner object of the pod, a resource hierarchy of the application is constructed. A backup specification for backup of the application is identified. Based on the backup specification and the resource hierarchy of the application, resources of the application are backed up.

### RELATED APPLICATIONS

Benefit is claimed under 35 U.S.C. 119(a)-(d) to Foreign Application Serial No. 202241042203 filed in India entitled “AUTOMATIC DISCOVERY OF APPLICATION RESOURCES FOR APPLICATION BACKUP IN A CONTAINER ORCHESTRATION PLATFORM”, on Jul. 22, 2022, by VMware, Inc., which is herein incorporated in its entirety by reference for all purposes.

### TECHNICAL FIELD

The present disclosure relates to computer-implemented methods, media, and systems for automatic discovery of application resources for application backup in a container orchestration platform (e.g., a Kubernetes system).

### BACKGROUND

Applications today are deployed onto a combination of virtual machines (VMs), containers, application services, and more. For deploying such applications, a container orchestration platform can be used. An example container orchestration platform includes a Kubernetes® system. Kubernetes provides a platform for automating deployment, scaling, and operations of application containers across clusters of hosts. It offers flexibility in application development and offers useful tools for scaling.

For data protection in scenarios such as disaster recovery, mobility and migration, a successful recovery of an application may require identifying all the resources associated with the application to be backed up to avoid missing any critical resources. An effective method for identifying application resources for backup is desirable.

### SUMMARY

The present disclosure involves computer-implemented method, medium, and system for automatic discovery of application resources for application backup in a container orchestration platform. In one example computer-implemented method, a pod of an application deployed in a container orchestration platform is identified. Then an owner object of the pod is determined. Resources mounted on the pod and on the owner object of the pod in the container orchestration platform are checked. Based on the pod, the owner object of the pod, and the resources mounted on the pod and on the owner object of the pod, a resource hierarchy of the application is constructed. A backup specification for backup of the application is identified. Based on the backup specification and the resource hierarchy of the application, resources of the application are backed up.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a schematic diagram illustrating an example computing system or environment that can execute implementations of the present disclosure.

FIG. 2 is a schematic diagram illustrating another example computing system or environment that can execute implementations of the present disclosure.

FIG. 3 is a schematic diagram illustrating an example Kubernetes cluster, in accordance with example implementations of this specification.

FIG. 4 is a flowchart illustrating an example method for automatic discovery of application resources for application backup in a Kubernetes system, in accordance with example implementations of this specification.

FIG. 5 is a schematic diagram illustrating an example visual representation of a resource hierarchy of an example application, in accordance with example implementations of this specification.

FIG. 6 is a flowchart illustrating an example method for automatic discovery of application resources for application backup in a container orchestration platform, in accordance with example implementations of this specification.

FIG. 7 is a schematic illustration of example computer systems that can be used to execute implementations of the present disclosure.

### DETAILED DESCRIPTION

This disclosure describes techniques for automatically discovering application resources for application backup in a container orchestration platform (e.g., a Kubernetes system). The described techniques can be used, for example, as data protection solutions that support backup of applications in the container orchestration platform. The applications in the container orchestration platform can be, for example, applications deployed in a Kubernetes cluster, also referred to as Kubernetes applications. In some implementations, frequent or periodic application backup in the Kubernetes system (also referred to as Kubernetes backup) can be used to protect changing Kubernetes resources, configurations and application data. The choice of frequency can be configured by a user (e.g., an operator of the application or an administrator of the Kubernetes system).

Application resources for application backup in the container orchestration platform can include resources that make up or constitute the application in the container orchestration platform. For example, the application resources can include objects, configurations, application data, and other workload or API resources that make up the application. As an example, for a Kubernetes application deployed in a Kubernetes system (e.g., in one or more Kubernetes clusters), the application resources can include application workload resources such as Kubernetes objects such as pods, services, secrets, configurations (e.g., ConfigMap), deployments, etc., that can be read and modified through a Kubernetes API server. In some implementations, the application workload resources can be distinguished from hardware compute resources, such as CPU and memory with measurable quantities. In some implementations, the application resources can also include data related to the application that are stored in a persistent volume (PV) or other storage device that is internal to or external of, but associated with, the Kubernetes clusters. In some implementations, the application resources are also referred to as resources of the application, API resources, Kubernetes application resources, Kubernetes resources, or workload resources.

In prior approaches, a full cluster backup can be created, where the entire cluster resources of every application running within in the Kubernetes cluster are backed up at a particular time or within a particular duration as scheduled. In some cases, the cluster enters an undesirable state in which a large number of changes are implemented but not yet backed up. This can happen e.g., while waiting for the backup to be scheduled. In this circumstance, the backed up data does not reflect the actual state of the Kubernetes cluster and the backed up data is less useful but still requires a large amount of storage space.

Some data protection solutions can back up resources based on a selection of a namespace. Such a namespace or label selector backup approach backs up only the resources that exist within the selected namespace (e.g., by backing up performing a search of resources having the selected namespace and backing up the resources having the selected namespace). If a resource does not fall under the selected namespace, the resource is missed from the backup (e.g., because the resource cannot be found by search using the selected namespace). In some implementations, some data protection solutions can back up resources based on a specification of a label selector, a Helm Chart, or an operator. Similarly, such a label selector backup approach backs up only the resources that have the specified label. If a resource has an incorrect label or does not have a label (e.g., by a configuration error or typo), the resources is missed from the backup.

Technology described below addresses these deficiencies by automatically identifying a comprehensive hierarchy of application resources in the container orchestration platform, and can help avoid missing resources that are needed for data protection or recovery. In some implementations, the described techniques can create a relational graph showcasing all the resources that are related to the application. In some implementations, upon every addition of a new resource, the graph can be restructured, thus enabling an incremental backup of selective resources for every new resource added. In some implementations, the described techniques can also help ease the tasks of the operators in periodically taking the backup as and when there are changes to the application environment. In some implementations, the described techniques can ensure that the dynamically changing application deployment configuration is always backed up appropriately.

This disclosure also describes techniques for providing a visual presentation of the application resources to operators of the container orchestration platform, which help the operators understand their application dependencies and allow for selective backup of the resources of their interest. Accordingly, both misconfiguration and huge backups can be avoided. For example, with a graph representing the hierarchy of the application resources, the operator can have a complete view of all the components associated with that application. In some implementations, with the automatic discovery, the described techniques can notify or recommend that the operator to perform a backup when new resources are added, or when new applications are deployed. In some implementations, the described techniques can provide suggestions or recommendations on backing up selective resources.

The described techniques can provide effective and efficient backup and recovery of application workloads of an application in a container orchestration platform (e.g., in a Kubernetes cluster). For example, the described techniques can identify relevant resources that make up a Kubernetes application beyond a specified namespace or a specified label selector, to ensure critical resources for the specified namespace or the specified label selector are included in the backup. In some implementations, the described techniques can capture resource deployed in another namespace but are relevant to or needed for data protection or recovery of the Kubernetes application with the specified namespace. In some implementations, the described techniques can also help remedy situations where resources are given incorrect labels or no labels, and still back up relevant resources with mismatched or skipped labels. In some implementations, the described techniques can automatically discover application resources without requiring an operator to keep track of all the resources using the label or namespace approach.

In some implementations, the described techniques can provide flexibility and customization for the application backup. For example, the described techniques can provide more levels of granularity, beyond namespaces or label selectors, and allow operators (or users) to select appropriate resources for backup. For example, compared to the namespace or label selector backup approach that backs up all resources within a certain namespace or with a certain label selector, the described techniques can allow a subset or part of the resources within a certain namespace or with a certain label selector to be backed up, for example, based on a user input or a pre-configured backup policy.

In some implementations, the described techniques can improve backup efficiency and save storage space, for example, compared to a full cluster backup which can be time consuming. The described techniques can back up resources that are relevant to the specified backup policy, and require less storage space and computational resources.

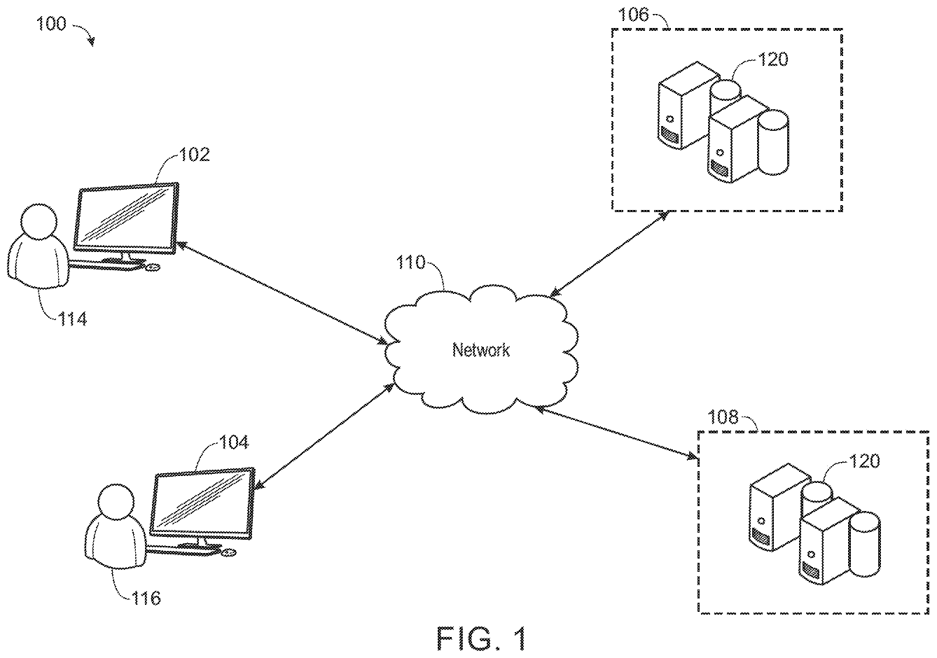

FIG. 1 is a schematic diagram illustrating an example computing system or environment 100 that can execute implementations of the present disclosure. In the depicted example, the example system 100 includes a client device 102, a client device 104, a network 110, a cloud environment 106, and a cloud environment 108. The cloud environment 106 may include one or more server devices and databases (e.g., processors, memory). In the depicted example, a user 114 interacts with the client device 102, and a user 116 interacts with the client device 104.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smartphone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems.

In some implementations, the cloud environment 106 includes at least one server and at least one data store 120. In the example of FIG. 1, the cloud environment 106 is intended to represent various forms of servers, including but not limited to, a web server, an application server, a proxy server, a network server, and/or a server pool. In general, server systems accept requests for application services and provide such services to any number of client devices (e.g., the client device 102 over the network 110).

In accordance with implementations of the present disclosure, the cloud environment 106 and/or cloud environment 108 can host applications and databases running on the host infrastructure. In some instances, the cloud environment 106 and/or cloud environment 108 can include multiple cluster nodes that can represent physical or virtual machines (VMs). A hosted application and/or service can run containerized applications on VMs hosted on cloud infrastructure. In some instances, one application and/or service can run as multiple application instances on multiple corresponding VMs, where each instance is running on a corresponding VM. In some implementations, the cloud environment 106 and/or cloud environment 108 can include a container orchestration platform (e.g., a Kubernetes system).

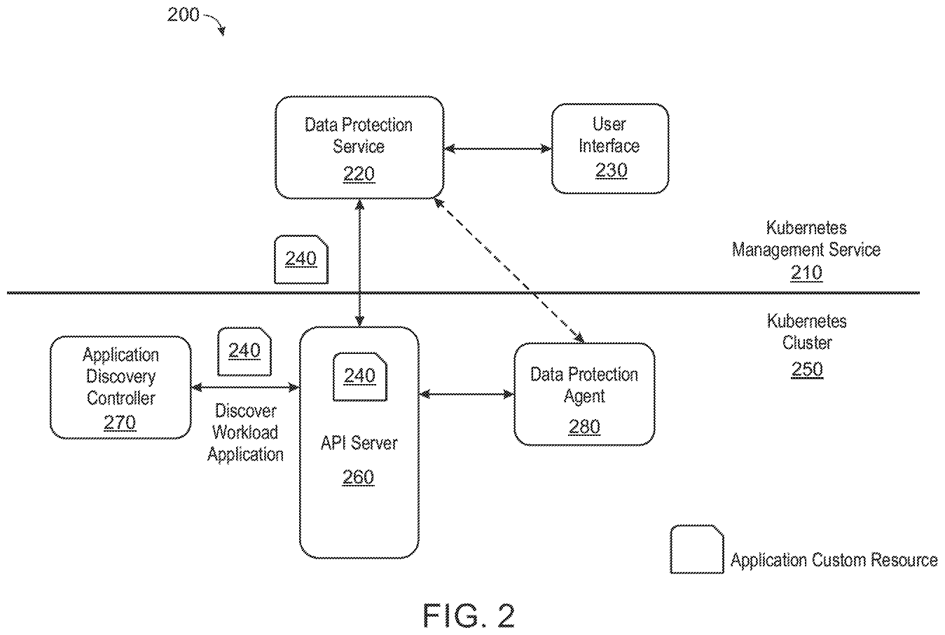

FIG. 2 is a schematic diagram illustrating another example computing system or environment 200 that can execute implementations of the presently disclosed technology. FIG. 2 can be an example architecture of the computing system 100 in FIG. 1 configured to perform automatic discovery of Kubernetes application resources for application backup, in accordance with example implementations of this specification. As shown, the computing system 200 includes a Kubernetes cluster 250 and a service backend, i.e., a Kubernetes management service 210. The Kubernetes management service 210 includes a data protection service 220 and a user interface 230. The Kubernetes cluster 250 includes an API server 260, an application discovery controller 270 (also referred to as an application detection controller), and a data protection agent 280. In some implementations, the computing system 200 can include additional or different components.

The Kubernetes cluster 250 can run workloads for an application (e.g., a Kubernetes application) using Kubernetes resources (e.g., pods, deployments, secrets, etc.). The Kubernetes management service 210 can provide data protection such as application backup through the data protection service 220. The data protection service 220 can be used to back up resources (e.g., Kubernetes resources in the Kubernetes cluster 250 and other application data) that make up the application or are required or helpful for data recovery of the application. For example, the data protection service 220 can call the data protection agent 280 to perform typical functions of data protection such as creating or deleting a backup, initiating or canceling a restore. In some implementations, the data protection agent 280 can interact with the data protection service 220 directly and/or through the API server 260. For example, the data protection agent 280 interacts with the API server 260 to retrieve and back up the resources.

The Kubernetes management service 210 can provide automatic visual representations of the Kubernetes application (e.g., in the form of a resource hierarchy of the application or an application resource graph) to users of the application users (e.g., the operators of the application or the administrator of the Kubernetes cluster 250), for example, through the user interface 230, so that the users can identify all the relevant resources easily. The Kubernetes management service 210 can allow the users to customize backup configurations to include resources of interests, for example, by selectively backing up the application resources of interest based on the presented resource hierarchy of the application through the user interface 230, thereby avoiding misconfiguration and large sized backups. In some implementations, the computing system 200 can also mitigate the risks of missing (i.e., leaving out) application resources from the backup that are required to fully restore the application from the backup in case of failure. Such risks are endemic to resource selections based on manual configuration such as label-selectors and namespace selection by the users.

The Kubernetes cluster 250 can run workloads of an applications (also referred to as application workloads) using Kubernetes resources. The Kubernetes resources can be scheduled and called through the API server 260. The application discovery controller 270 is deployed in the Kubernetes cluster 250 to perform automatic discovery of Kubernetes resources of an application. In some implementations, the application discovery controller 270 can watch on resource changes in the Kubernetes cluster 250 to discover all the resources constituting the application workloads and build resource hierarchies to represent the application workloads along with auto-generation of the backup configuration needed to comprehensively backup the application.

In some implementations, the application discovery controller 270 interacts with the API server 260 to discover Kubernetes resources of an application, and constructs a resource hierarchy of the application based on the discovered Kubernetes resources, store the resource hierarchy of the application in a data structure such as an application custom resource 240, and send the application custom resource 240 to the API server 260. The API server 260 can store the application custom resource 240 and send the application custom resource 240 to the data protection service 220. The data protection service 220 can use the application custom resource 240 to render a visual representation of the resource hierarchy of the application (e.g., an application resource graph) using the user interface 230 to present to the users.

In some implementations, the application discovery controller 270 constantly monitors the Kubernetes resources of the application, and updates the resource hierarchy of the application. The application discovery controller 270 can propagate the resource hierarchy of the application (e.g., stored in the application custom resource 240) back to the Kubernetes management service 210, either directly or indirectly through the API server 260. In some implementations, the application discovery controller 270 can also generate backup recommendations based on the resource hierarchy of the application. In some implementations, both the resource hierarchy of the application and the backup recommendations are sent from the application discovery controller 270 to the data protection service 220. The data protection service 220 can present the visual representation of the application to the users to help the users visualize their applications and allow selective backup resources of the application in an efficient and effectively manner, and achieve technical advantages such as taking the full advantage of backups and avoiding any loss of resource data. Any new applications deployed on the cluster subsequently can be automatically discovered and backed up based on user-defined backup policy, thus achieving a complete backup at any moment of time.

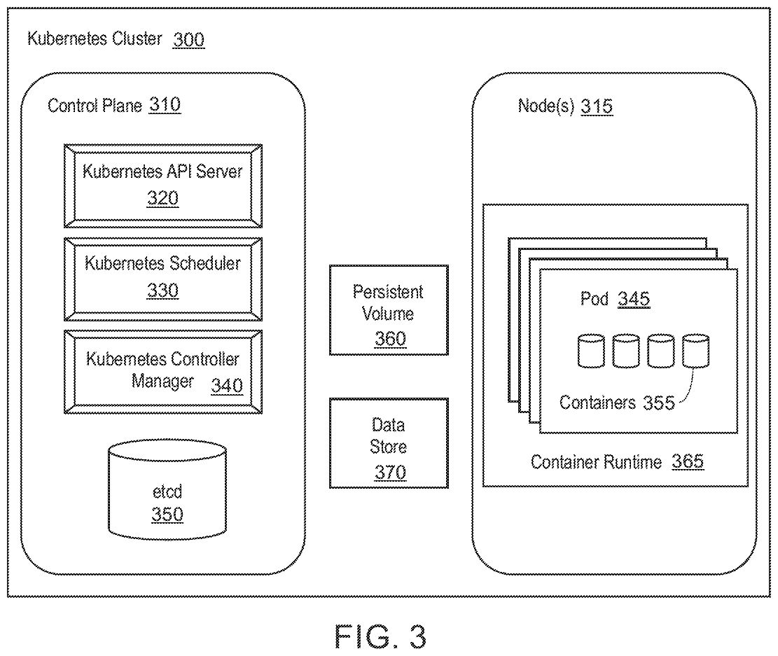

FIG. 3 is a schematic diagram illustrating an example Kubernetes cluster 300, in accordance with example implementations of this specification. The Kubernetes cluster 300 can be an example implementation of the Kubernetes cluster 250 in FIG. 2, for example, for implementing containerized applications using Kubernetes workload resources. As shown, the Kubernetes cluster 300 includes a control plane 310, one or more nodes 315 (also referred to as Kubernetes nodes or worker nodes), and a persistent volume (PV) 360. In some implementations, the Kubernetes cluster 300 can also be connected with one or more additional data stores 370, either internally or externally (e.g., a remote cloud storage). The Kubernetes cluster 300 can include additional or different components (e.g., Kubelet, Kubernetes proxy).

Each of the one or more nodes 315 can include a container runtime 365 for running containerized applications. In some implementations, the smallest unit of execution for an application running in Kubernetes is a Kubernetes pod (also referred to as a pod). A pod can include one or more containers. Kubernetes Pods run on worker nodes. Each Pod contains the code and storage resources required for execution and has its own IP address. Pods include configuration options as well. Typically, a Pod contains a single container or few containers that are coupled into an application or business function and that share a set of resources and data.

As shown, the container runtime 365 can include multiple pods 345, with each pod 345 representing a group of one or more application containers 355, and some shared resources for those containers 355. Containers 355 in the same pod share the same resources and network, and maintain a degree of isolation from containers in other pods. In some implementations, multiple pods 345 can be distributed across the nodes 315 of the Kubernetes cluster 300.

The control plane 310 includes a Kubernetes API server 320, a Kubernetes scheduler 330, a Kubernetes controller manager 340, and an etcd 350. The Kubernetes API server 320 can be an example of the API server 260 in FIG. 2. The Kubernetes scheduler 330 can be used to schedule pods to run applications in Kubernetes cluster. The Kubernetes controller manager 340 includes a daemon (not shown) that embeds core control loops shipped with Kubernetes such as replication controller, endpoints controller, namespace controller, and service accounts controller. The etcd 350 is a data store that stores Kubernetes resources, such as Secrets, ConfigMaps and Deployments.

The Persistent Volume (PV) 360 is a piece of storage in the Kubernetes cluster 300 which can be manually provisioned by an administrator, or dynamically provisioned by Kubernetes, e.g., using a StorageClass. A Persistent Volume Claim (PVC) is a request for storage by a user that can be fulfilled by a PV. In some implementations, PVs and PVCs are independent from lifecycles of a Pod and preserve data through restarting, rescheduling, and even deleting the pod.

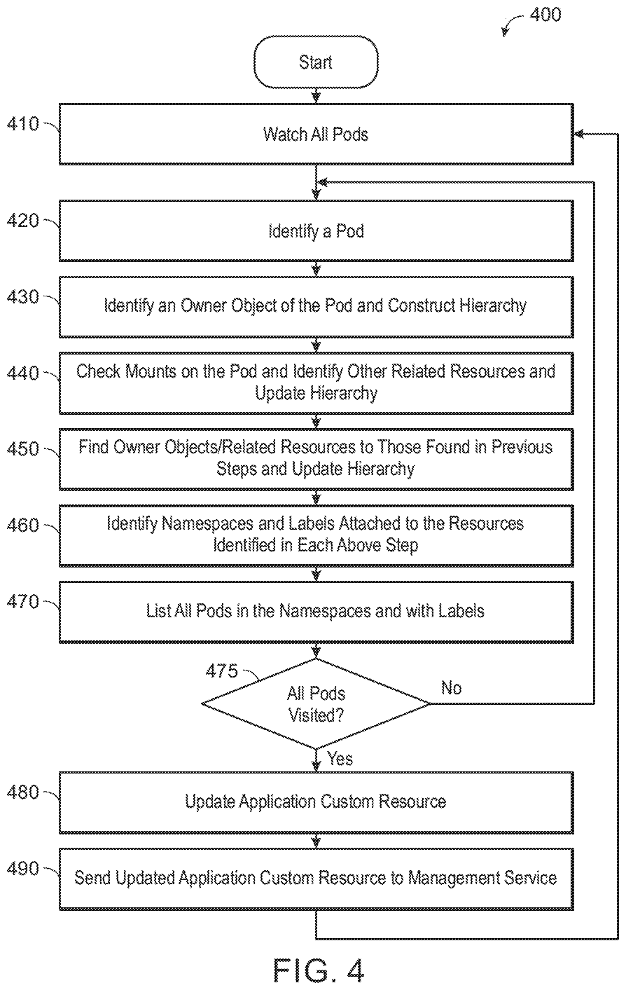

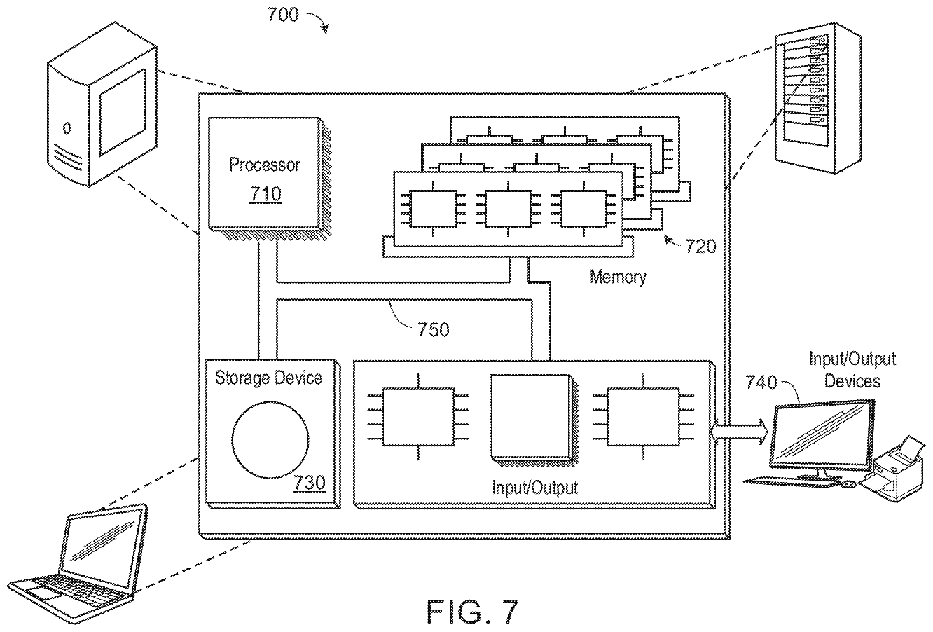

FIG. 4 is a flowchart illustrating an example method 400 for automatic discovery of application resources for application backup in a container orchestration platform (e.g., a Kubernetes system), in accordance with example implementations of technology described herein. In some implementations, the example method 400 can be performed by a controller, agent, or engine (any of which may be referred to as a controller) deployed on the cluster or in a Kubernetes management plane. The controller can be the application discovery controller 270 in FIG. 2. The controller can be implemented by software, hardware, or a combination thereof. In some implementations, the example method 400 can be performed, for example, according to techniques described with reference to FIGS. 1-3 and 5-6. The example method 400 can be implemented by a data processing apparatus or a computer-implemented device or system (referred to as a computing system) such as the computing system 100, 200, 700 as shown in FIGS. 1, 2, and 7. In some implementations, a computing system can be a system of one or more computers, located in one or more locations, and programmed appropriately in accordance with this disclosure. For example, a computing system 700 in FIG. 7, appropriately programmed, can perform the example process 400. In some implementations, the example method 400 can be implemented on or in conjunction with a Digital Signal Processor (DSP), Field Programmable Gate Array (FPGA), processor, controller, and/or a hardware semiconductor chip, etc.

In some implementations, the example process 400 shown in FIG. 4 can be modified or reconfigured to include additional, fewer, or different operations, which can be performed in the order shown or in a different order. In some instances, one or more of the operations can be repeated or iterated, for example, until a terminating condition is reached. In some implementations, one or more of the individual operations shown in FIG. 4 can be executed as multiple separate operations, or one or more subsets of the operations shown in FIG. 4 can be combined and executed as a single operation.

At 410, the controller watches or monitors a plurality of pods in a Kubernetes clusters. A pod is a type of Kubernetes resources that makes up an application. In some implementations, the plurality of pods can be all the pods in the Kubernetes clusters, or a subset of all the pods in the Kubernetes clusters. To perform the watch, the controller can subscribe or register with a process connector service in order to receive notifications of events on different types of resources in the Kubernetes clusters. For example, the controller subscribes for events from Kubernetes controller manager 340. It can be specified that the desired to-be reported events are events on the pod type of resource.

At 420, the controller identifies a pod among the plurality of pods, for example, in response to receiving or detecting an event on the pod. For example, an event occurs on a pod and the event is reported to the controller. The event contains an identifier of a pod which generates the event and the type of event (e.g., Created, Deleted, or Updated).

At 430, the controller checks an owner object of the pod. In Kubernetes, some objects are owners of other objects. For example, a Replica Set is the owner of a set of pods. These owned objects are dependents of their owner objects. Dependent objects have a metadata.ownerReferences field that references their owner object. In some implementations, the controller checks an owner object of the pod by checking an owner reference (e.g., the metadata.ownerReferences field) of the pod. As an example, the controller can check if the owner reference of a Pod points to a Daemon Set. As an example, the controller can check if the owner reference of a Pod points to a Stateful Set.

In some implementations, the controller checks an owner object of the pod in an iterative manner until reaching a point where no owner object is identified. For example, if the owner reference of a Pod points to a Replica Set, the controller can check the owner reference of the Replica Set to determine whether it is created for a Deployment. If the owner reference of a Pod points to a Job, the controller can check the owner reference of the Job to determine whether it is created for a CronJob.

In some implementations, after identifying one or more owner objects of the pod, the controller can start constructing a resource hierarchy of the application. The resource hierarchy of the application can include an arrangement of resources objects that are represented as being “above”, “below”, or “at the same level as” one another. For example, a resource hierarchy of the application can include a pod at a bottom level, a first owner object of the pod at the middle level, and a second owner object of the first owner object at a high level of the resource hierarchy, until reaching an end or top level of the resource hierarchy.

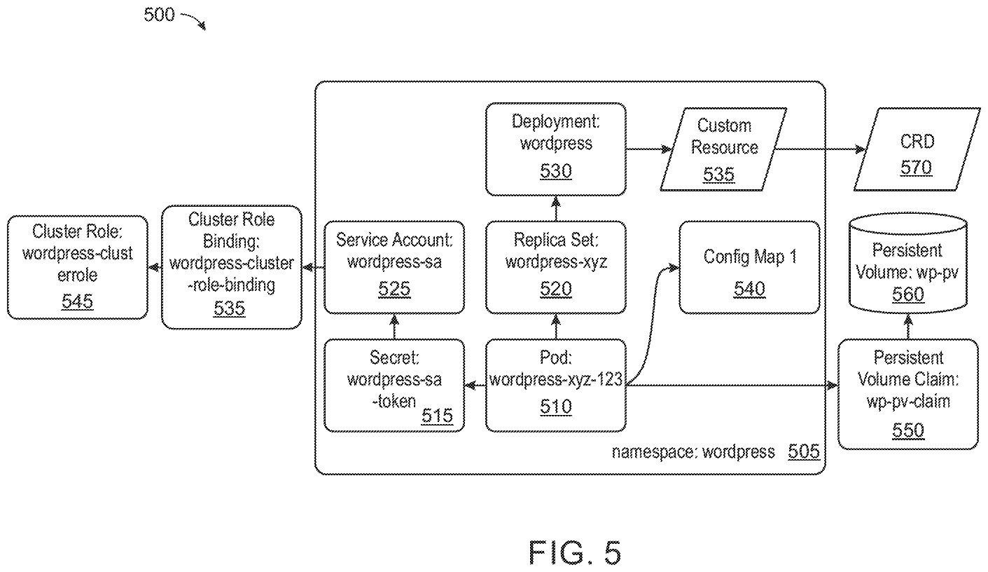

FIG. 5 is a schematic diagram illustrating an example visual representation of a resource hierarchy 500 of an example application, in accordance with example implementations of this specification. The example application is a WordPress application that has a namespace of “wordpress” 505. The WordPress application is running on a Kubernetes cluster using a plurality of Kubernetes resources and is made up of or supported by multiple resources as shown, such as a pod “wordpress-xyz-123” 510, a replica set “wordpress-xyz” 520, a deployment “wordpress” 530, etc. The pod wordpress-xyz-123 510 can be identified, for example, according to the example techniques described above with reference to step 420. The replica set wordpress-xyz 520 can be identified, for example, according to the example techniques described with reference to step 430, as an owner object of the pod wordpress-xyz-123 510. The deployment wordpress 530 can also be identified according to the example techniques described with reference to step 430, as an owner object of the replica set wordpress-xyz 520. The visual representation of the resource hierarchy 500 shows the pod wordpress-xyz-123 510 at a bottom level, the replica set wordpress-xyz 520 on the middle level (i.e., visually above the pod wordpress-xyz-123 510) and the deployment wordpress 530 on a top level of the resource hierarchy 500 (i.e., visually above the replica set wordpress-xyz 520).

At 440, the controller checks mounts on the pod and identifies other connected or related resources. The mounts on the pod are resources that are attached to or associated with the pod such that the pod can access. The mounts can include, for example, secrets, ConfigMaps, Persistent Volume Claims, and other resources. The controller can identify other connected resources based on the mounts. For example, the controller can use Persistent Volume Claims to identify Persistent Volumes. In some implementations, the controller can check service accounts, which might be identified, for example, based on the namespace of the pod, or secrets that mounted on the pod. The controller can use Service Account to identify RoleBinding/ClusterRoleBinding and Role/ClusterRole.

In the example resource hierarchy 500, a secret, such as wordpress-sa-token 515, Persistent Volume Claims wp-pv-claim 550, and Config Map 1 540 can be identified, for example, according to the example techniques described with respect to step 440 as mounts of the pod wordpress-xyz-123 510. Other connected resources can include a service account wordpress-sa 525 identified based on the secret wordpress-sa-token 515, a Persistent Volume wp-pv 560 identified based on the Persistent Volume Claims wp-pv-claim 550 a wordpress-cluster-role-binding 535, and a Cluster Role wordpress-cluster-role 545, which are identified based on the service account wordpress-sa 525.

In some implementations, the controller can update the resource hierarchy of the application based on the identified mounts on the pod and other related resources. For example, in FIG. 5, the example resource hierarchy 500 can be updated to include the identified mounts on the pod and other connected resources after identifying the pod 510 and the one or more owner objects 520 of the pod.

At 450, the controller checks owner objects and/or related resources to those resources found in one or more previous steps such as steps 430 and 440 and update the resource hierarchy of the application accordingly. For example, the controller can check the owner objects in an iterative manner until no further owner object is identified (especially if it has not been done in step 430). Using the example in FIG. 5, the controller can identify the replica set wordpress-xyz 520 as the owner object of the pod wordpress-xyz-123 510, for example, according to the example techniques described above with respect to step 430. Similarly, the controller can identify the deployment wordpress 530 as the owner object of the replica set wordpress-xyz 520, for example, according to the example techniques described above with respect to step 430.

Additionally, the controller can identify a custom resource 535, as a related resource to the deployment wordpress 530, and a CRD 570 as a related resource to the custom resource 535. In some implementations, the controller can use Role or ClusterRole to identify any Custom Resource Definitions (CRDs) used by the controller in the workload pods. For example, the controller can use the Cluster Role wordpress-cluster-role 545 to identify the CRD 570 as a related resource to the Cluster Role wordpress-cluster-role 545.

The example resource hierarchy 500 can be updated to include the owner objects and/or related resources such as the replica set wordpress-xyz 520, the deployment wordpress 530, the custom resource 535, and CRD 570 accordingly.

In some implementations, the controller will additionally discover workload application packages like Helm charts and other packages in a Kubernetes platform and construct Application resource graphs by parsing their resource manifests.

In some implementations, resources like Custom Resource Definitions, Custom Resources, Secrets and ConfigMaps can be missed if they are accessed by the application workloads in the controller runtime using the API server or using service accounts using cluster admin roles. To address this, in some implementations, the controller can list resources in namespaces identified and also use identified labels to try and find the standalone resources. In some implementations, the Kubernetes Management Plane can allow operators to customize the backup configuration to include such resources.

At 460, the controller can identify namespaces and/or labels attached to the resources identified in steps 420-450.

At 470, the controller can list resources identified in steps 420-450 in namespaces with labels.

At 475, the controller determines if all the pods in the Kubernetes cluster has been visited. If so, the example method 400 proceeds to 480. If not, the example method 400 goes back to 420 to another pod and repeat the above process.

In some implementations, constructing or updating of the resource hierarchy can be performed in each of the steps 420-470 if an additional or updated resource is identified. In some implementations, constructing or updating of the resource hierarchy can be performed after all pods have been visited and resources on all the pods are identified. In some implementations, constructing or updating of the resource hierarchy can be performed in some of the steps or after a few steps have been completed. Various implementations can be performed.

At 480, the controller generates or updates an Application Custom Resource to describe, specify or record the resource hierarchy of the application. In some implementations, an application Custom Resource can be a data structure as a part of the Custom Resource Definition (CRD) of an application. Table 1 shows an example of the data structure. In some implementations, the data structure can include additional or different components and can have another format.

TABLE 1

Application
Name string
Labels map[string]string
Namespaces [ ] string
Resources [ ]*ApplicationResource
StandaloneResources [ ]*ApplicationResource
ApplicationResource
GVK GroupVersionKind - Name string
Namespace string
Labels map[string]string
Children [ ]*ApplicationResource
Siblings [ ]*ApplicationResource
GroupVersionKind
Group string
Version string
Kind string

At 490, the controller sends the Application Custom Resource to a management service e.g., the Kubernetes management service 210 according to the example techniques described above with reference to FIG. 2.

In some implementations, using the example method 400, the controller can automatically identify the application and the namespaces, label selectors, individual resources needed to back up the application workload and any additional standalone resources like Custom Resource Definitions (CRD). The application workload resource graph information can be used, for example, by the Kubernetes Control Plane, to provide a graphical presentation of application workloads.

In some implementations, using the identified application resources, the controller can generate backup suggestions. In some implementations, as described with reference to FIG. 2, a Data Protection Control Plane (e.g., Kubernetes management service 210) can present the backup suggestions to the operator of the Kubernetes cluster. The backup suggestions can be accepted and additionally customized by the operator, if needed, for example, to formulate the backup policy. In some implementations, the backup policy can be configured on a per-user or per-application basis (e.g., specific to an application or a namespace or label of the application). In some implementations, the backup policy can be configured to be application generic (e.g., applicable to all applications, or applications with different namespaces or labels). In some implementations, new application resource deployed on the cluster can be immediately discovered and can be automatically backed up per the backup policy.

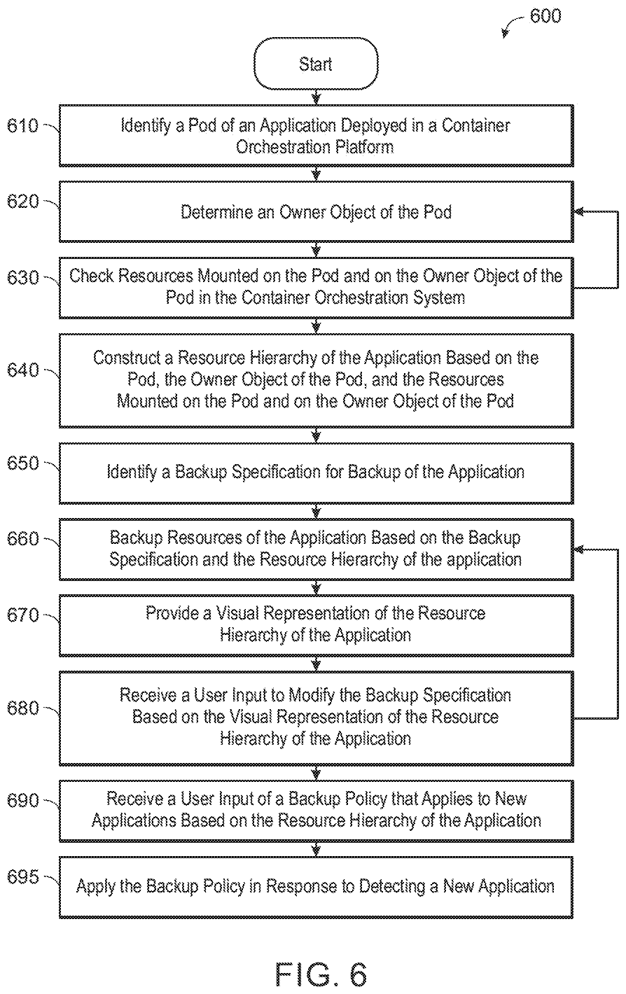

FIG. 6 is a flowchart illustrating an example method for automatic discovery of application resources for application backup in a container orchestration platform (e.g., a Kubernetes system) in accordance with example implementations of this specification. In some implementations, some or all operations of the example method 600 can be performed by a controller, agent, or engine (any of which may be referred to as a controller) deployed on the cluster or in a Kubernetes management plane. The controller can be the application discovery controller 270 in FIG. 2. The controller can be implemented by software, hardware, or a combination thereof. In some implementations, the example method 600 can be performed, for example, according to techniques described with respect to FIGS. 1-5 and can be implemented by a data processing apparatus or a computer-implemented device or system (referred to as a computing system) such as the computing system 100, 200, 700 as shown in FIGS. 1, 2, and 7. In some implementations, a computing system can be a system of one or more computers, located in one or more locations, and programmed appropriately in accordance with this disclosure. For example, a computing system 700 in FIG. 7, appropriately programmed, can perform the example process 600. In some implementations, the example method 600 can be implemented on or in conjunction with a digital signal processor (DSP), field programmable gate array (FPGA), processor, controller, or a hardware semiconductor chip, etc.

In some implementations, the example process 600 shown in FIG. 6 can be modified or reconfigured to include additional, fewer, or different operations, which can be performed in the order shown or in a different order. In some instances, one or more of the operations can be repeated or iterated, for example, until a terminating condition is reached. In some implementations, one or more of the individual operations shown in FIG. 6 can be executed as multiple separate operations, or one or more subsets of the operations shown in FIG. 6 can be combined and executed as a single operation.

At 610, a pod of an application deployed in a container orchestration platform is identified, for example, according to the example techniques described with respect to step 420. For example, identifying the pod of the application comprises identifying the pod of the application in response to detecting a change event on the pod. The application comprises a plurality of pods and the pod can be one of the plurality of pods of the application deployed in the container orchestration platform. In some implementations, the container orchestration platform comprises a Kubernetes system, and the resources of the application comprises the pod and other Kubernetes resources of the application, wherein the other Kubernetes resources comprise one or more of a persistent volume, a custom resource definition, a custom resource, a service account, etc.

At 620, an owner object of the pod is determined, for example, according to the example techniques described with respect to step 430.

At 630, resources mounted on the pod and on the owner object of the pod in the container orchestration platform are checked, for example, according to the example techniques described with respect to step 440. In some implementations, the resources mounted on the pod and on the owner object of the pod comprise the mounts and other related resources as described with respect to 440, such as, one or more of a persistent volume claim, a local storage device, a path on a host device, a secret, a ConfigMap, etc.

In some implementations, steps 620 and 630 can be performed in an iterative or recursive manner until no further owner object or mounted resources are identified, for example, according to the example techniques described with respect to step 450. For example, the method 600 can further include determining an owner object of the owner object of the pod, and wherein constructing the resource hierarchy of the application based the pod, the owner object of the pod, and the resources mounted on the pod and on the owner object of the pod comprises constructing the resource hierarchy of the application based on the pod, the owner object of the pod, and the owner object of the owner object of the pod.

At 640, a resource hierarchy of the application is constructed based on the pod, the owner object of the pod, and the resources mounted on the pod and on the owner object of the pod. In some implementations, the resource hierarchy of the application is constructed, for example, according to the example techniques described with respect to step 430.

In some implementations, constructing the resource hierarchy of the application includes updating the resource hierarchy of the application, for example, based on newly identified resources, for example, according to the example techniques described with respect to steps 430-480.

In some implementations, constructing the resource hierarchy of the application comprises creating a data structure (e.g., the Application Custom Resource, a graph, a table, a tree, or another data structure) to represent the resource hierarchy of the application, for example, according to the example techniques described with respect to step 480.

In some implementations, the application comprises a plurality of pods. The steps 610-640 can be repeated for each of the plurality of pods. Constructing the resource hierarchy of the application based the pod, the owner object of the pod, and the resources mounted on the pod and on the owner object of the pod comprises constructing the resource hierarchy of the application based the plurality of pods, respective owner objects of the plurality of pods, and respective resources mounted on the plurality of pods and the respective owner objects of the plurality of pods.

In some implementations, the method 600 can further include identifying namespaces and/or labels attached to the resources identified in steps 610-650, for example, according to the example techniques described with respect to steps 460-470. For example, the method 600 can comprise identifying one or more namespaces of the resources of the application; identifying resources within the one or more namespaces; and identifying the backup specification comprises identifying the backup specification using the one or more namespaces and the resources within the one or more namespaces. For example, the method 600 can comprise identifying one or more labels of the resources of the application; identifying resources with the one or more labels; and identifying the backup specification comprises identifying the backup specification using the one or more labels and the resources within the one or more labels.

At 650, a backup specification for backup of the application is identified. In some implementations, the backup specification includes one or more conditions, rules, policies, or filters that are expected by the computing system for the backup of the application. In some implementations, identifying the backup specification for backup of the application comprises determining or deriving a backup specification for backup of the application based on the resource hierarchy of the application, for example, by automatically selecting some or all identified resources in the resource hierarchy of the application, and/or providing a recommendation on sources to be backed up among the identified resources in the resource hierarchy of the application.

At 660, resources of the application are backed up based on the backup specification and the resource hierarchy of the application, for example, according to the example techniques described with respect to FIG. 2. For example, the resources of the application are resourced selected according to the backup specification among the identified resources in the resource hierarchy of the application. In some implementations, a subset or part of the resources within a certain namespace or with a certain label selector are backed up, for example, based on the backup specification and the resource hierarchy of the application.

At 670, a visual representation of the resource hierarchy of the application is provided, for example, via a user interface according to the example techniques described with respect to FIGS. 2, 4 and 5. For example, FIG. 5 shows an example visual representation of a resource hierarchy 500 of the example application, WordPress. In some implementations, the step 670 can be performed prior to, or in parallel with step 660.

At 680, a user input to modify the backup specification based on the visual representation of the resource hierarchy of the application is received, for example, via a user interface according to the example techniques described with respect to FIGS. 2, 4 and 5. In some implementations, modifying the backup specification include confirming, appending, deleting, or otherwise managing the backup specification (e.g., a default backup specification or the backup specification provided or recommended in step 650). In some implementations, after receiving the user input to modify the backup specification, the method 600 may go back to step 660 to back up the resources of the application based on the modified backup specification.

At 690, a user input of a backup policy that applies to new applications based on the resource hierarchy of the application is received, for example, via a user interface according to the example techniques described with respect to FIGS. 2, 4 and 5. In some implementations, the step 690 can be a part of the step 680. For example, the backup policy that applies to new applications can be used to modify the backup specification. In some implementations, the backup policy that applies to new applications can be based on, for example, one or more namespaces or labels. In some implementations, the backup policy that applies to new applications can application-specific. For example, the backup policy may be based on one or more namespaces or labels of a specific application. In some implementations, the backup policy that applies to new applications can be specific to a particular new application or can be applicable to all applications subsequently deployed in the container orchestration platform.

At 695, in response to detecting a new application, the backup policy is applied to the new application. In some implementations, once the new application is deployed and running in the container orchestration platform, the steps 610-690 can be automatically executed to identify recourses that makes up the new application, construct a resource hierarchy of the new application, identify a backup specification for the new application (e.g., based on the backup policy), and back up the resources for the new application. In some implementations, the backup the new application can be an incremental backup. For example, in some implementations, a time-stamp with each resource identified for an application can be added to the data structure representing the resource hierarchy of the application or metadata. The time-stamp can be used as a reference point to determine if incremental backup can be implemented, for example, to improve efficiency and saving storage space. In some implementations, the method 600 can be running on a backend of a computing system that provide real-time, constant, regular, or on-demand data protection.

FIG. 7 is a schematic illustration of example computer systems that can be used to execute implementations of the present disclosure. The system 700 can be used for the operations described in association with the implementations described herein. For example, the system 700 may be included in any or all of the server components discussed herein. The system 700 includes a processor 710, a memory 720, a storage device 730, and an input/output device 740. The components 710, 720, 730, and 740 are interconnected using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. In some implementations, the memory 1120 is a volatile memory unit. In some implementations, the memory 720 is a non-volatile memory unit. The storage device 730 is capable of providing mass storage for the system 700. In some implementations, the storage device 730 is a computer-readable medium. In some implementations, the storage device 730 may be a floppy disk device, a hard disk device, an optical disk device, or a tape device. The input/output device 740 provides input/output operations for the system 700. In some implementations, the input/output device 740 includes a keyboard and/or pointing device. In some implementations, the input/output device 740 includes a display unit for displaying graphical user interfaces.

Certain aspects of the subject matter described here can be implemented as a computer-implemented method. In some implementations, the computer-implemented method includes identifying a pod of an application deployed in a container orchestration platform; determining an owner object of the pod; checking resources mounted on the pod and on the owner object of the pod in the container orchestration platform; constructing a resource hierarchy of the application based on the pod, the owner object of the pod, and the resources mounted on the pod and on the owner object of the pod; identifying a backup specification for backup of the application; and backing up resources of the application based on the backup specification and the resource hierarchy of the application.

An aspect taken alone or combinable with any other aspect includes the following features. The container orchestration platform comprises a Kubernetes system, and the resources of the application comprises the pod and other Kubernetes resources of the application, wherein the other Kubernetes resources comprise one or more of a persistent volume, a custom resource definition, a custom resource, or a service account.

An aspect taken alone or combinable with any other aspect includes the following features. The resources mounted on the pod and on the owner object of the pod comprise one or more of a persistent volume claim, a local storage device, a path on a host device, a secret, or a ConfigMap.

An aspect taken alone or combinable with any other aspect includes the following features. The application comprises a plurality of pods, and constructing the resource hierarchy of the application based the pod, the owner object of the pod, and the resources mounted on the pod and on the owner object of the pod comprises constructing the resource hierarchy of the application based the plurality of pods, respective owner objects of the plurality of pods, and respective resources mounted on the plurality of pods and the respective owner objects of the plurality of pods.

An aspect taken alone or combinable with any other aspect includes the following features. Identifying the pod of the application comprises identifying the pod of the application in response to detecting a change event on the pod.

An aspect taken alone or combinable with any other aspect includes the following features. The computer-implemented method further includes determining an owner object of the owner object of the pod, and wherein constructing the resource hierarchy of the application based the pod, the owner object of the pod, and the resources mounted on the pod and on the owner object of the pod comprises constructing the resource hierarchy of the application based on the pod, the owner object of the pod, and the owner object of the owner object of the pod.

An aspect taken alone or combinable with any other aspect includes the following features. Constructing the resource hierarchy of the application comprises creating a data structure to represent the resource hierarchy of the application.

An aspect taken alone or combinable with any other aspect includes the following features. The computer-implemented method further includes providing a visual representation of the resource hierarchy of the application; and receiving a user input to modify the backup specification based on the visual representation of the resource hierarchy of the application.

An aspect taken alone or combinable with any other aspect includes the following features. The computer-implemented method further includes receiving a user input of a backup policy that applies to new applications based on the resource hierarchy of the application; and applying the backup policy in response to detecting a new application.

An aspect taken alone or combinable with any other aspect includes the following features. The computer-implemented method further includes identifying one or more namespaces of the resources of the application; identifying resources within the one or more namespaces; and identifying the backup specification comprises identifying the backup specification using the one or more namespaces and the resources within the one or more namespaces.

An aspect taken alone or combinable with any other aspect includes the following features. The computer-implemented method further includes identifying one or more labels of the resources of the application; identifying resources with the one or more labels; and identifying the backup specification comprises identifying the backup specification using the one or more labels and the resources within the one or more labels.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method, comprising:
identifying a pod of an application deployed in a container orchestration platform;
determining an owner object of the pod;
checking resources mounted on the pod and on the owner object of the pod in the container orchestration platform;
constructing a resource hierarchy of the application based on the pod, the owner object of the pod, and the resources mounted on the pod and on the owner object of the pod;
identifying a backup specification for backup of the application; and
backing up resources of the application based on the backup specification and the resource hierarchy of the application.

2. The computer-implemented method of claim 1, wherein the container orchestration platform comprises a Kubernetes system, and the resources of the application comprises the pod and other Kubernetes resources of the application, wherein the other Kubernetes resources comprise one or more of a persistent volume, a custom resource definition, a custom resource, or a service account.

3. The computer-implemented method of claim 1, wherein the resources mounted on the pod and on the owner object of the pod comprise one or more of a persistent volume claim, a local storage device, a path on a host device, a secret, or a ConfigMap.

4. The computer-implemented method of claim 1, wherein:
the application comprises a plurality of pods, and
constructing the resource hierarchy of the application based the pod, the owner object of the pod, and the resources mounted on the pod and on the owner object of the pod comprises constructing the resource hierarchy of the application based the plurality of pods, respective owner objects of the plurality of pods, and respective resources mounted on the plurality of pods and the respective owner objects of the plurality of pods.

5. The computer-implemented method of claim 1, wherein identifying the pod of the application comprises identifying the pod of the application in response to detecting a change event on the pod.

6. The computer-implemented method of claim 1, further comprising:
determining an owner object of the owner object of the pod, and
wherein constructing the resource hierarchy of the application based the pod, the owner object of the pod, and the resources mounted on the pod and on the owner object of the pod comprises constructing the resource hierarchy of the application based on the pod, the owner object of the pod, and the owner object of the owner object of the pod.

7. The computer-implemented method of claim 1, wherein constructing the resource hierarchy of the application comprises creating a data structure to represent the resource hierarchy of the application.

8. The computer-implemented method of claim 1, further comprising:
providing a visual representation of the resource hierarchy of the application; and
receiving a user input to modify the backup specification based on the visual representation of the resource hierarchy of the application.

9. The computer-implemented method of claim 1, further comprising:
receiving a user input of a backup policy that applies to new applications based on the resource hierarchy of the application; and
applying the backup policy in response to detecting a new application.

10. The computer-implemented method of claim 1, further comprising:
identifying one or more namespaces of the resources of the application;
identifying resources within the one or more namespaces; and
identifying the backup specification comprises identifying the backup specification using the one or more namespaces and the resources within the one or more namespaces.

11. The computer-implemented method of claim 1, further comprising:
identifying one or more labels of the resources of the application;
identifying resources with the one or more labels; and
identifying the backup specification comprises identifying the backup specification using the one or more labels and the resources within the one or more labels.

12. A non-transitory, computer-readable medium storing one or more instructions executable by a computer system to perform operations, the operations comprising:
identifying a pod of an application deployed in a container orchestration platform; determining an owner object of the pod;
checking resources mounted on the pod and on the owner object of the pod in the container orchestration platform;
constructing a resource hierarchy of the application based on the pod, the owner object of the pod, and the resources mounted on the pod and on the owner object of the pod;
identifying a backup specification for backup of the application; and
backing up resources of the application based on the backup specification and the resource hierarchy of the application.

13. The non-transitory, computer-readable medium of claim 12, wherein the container orchestration platform comprises a Kubernetes system, and the resources of the application comprises the pod and other Kubernetes resources of the application, wherein the other Kubernetes resources comprise one or more of a persistent volume, a custom resource definition, a custom resource, or a service account.

14. The non-transitory, computer-readable medium of claim 12, wherein the operations further comprise:
determining an owner object of the owner object of the pod, and
wherein constructing the resource hierarchy of the application based the pod, the owner object of the pod, and the resources mounted on the pod and on the owner object of the pod comprises constructing the resource hierarchy of the application based on the pod, the owner object of the pod, and the owner object of the owner object of the pod.

15. The non-transitory, computer-readable medium of claim 12, wherein constructing the resource hierarchy of the application comprises creating a data structure to represent the resource hierarchy of the application.

16. The non-transitory, computer-readable medium of claim 12, wherein the operations further comprise:
providing a visual representation of the resource hierarchy of the application; and
receiving a user input to modify the backup specification based on the visual representation of the resource hierarchy of the application.

17. The non-transitory, computer-readable medium of claim 12, wherein the operations further comprise:
receiving a user input of a backup policy that applies to new applications based on the resource hierarchy of the application; and
applying the backup policy in response to detecting a new application.

18. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, the one or more operations comprising:
identifying a pod of an application deployed in a container orchestration platform; determining an owner object of the pod;
checking resources mounted on the pod and on the owner object of the pod in the container orchestration platform;
constructing a resource hierarchy of the application based on the pod, the owner object of the pod, and the resources mounted on the pod and on the owner object of the pod;
identifying a backup specification for backup of the application; and
backing up resources of the application based on the backup specification and the resource hierarchy of the application.

19. The computer-implemented system of claim 18, wherein constructing the resource hierarchy of the application comprises creating a data structure to represent the resource hierarchy of the application.

20. The computer-implemented system of claim 18, wherein the operations further comprise:
providing a visual representation of the resource hierarchy of the application; and
receiving a user input to modify the backup specification based on the visual representation of the resource hierarchy of the application.
